(19) United States
(12) Patent Application Publication
(10) Pub. No.: US 2026/0172311 A1
(43) Pub. Date: Jun. 18, 2026

(54) BINDING RESTORATION ENGINE(S) FOR ENABLING INITIATION OF IMS-BASED SESSIONS WITHOUT BINDINGS

(71) Applicant: Oracle International Corporation, Redwood City, CA (US)

(72) Inventors: Avin George, Bengaluru (IN); Geeta Mohanty, Bengaluru (IN); Rajiv Krishan, Cary, NC (US); Abhishek Mukherjee, Bengaluru (IN)

(21) Appl. No.: 18/983,627

(22) Filed: Dec. 17, 2024

(51) Int. Cl. H04L 41/0894; H04L 41/12; H04L 65/1016; H04L 65/1069

(52) U.S. Cl. CPC H04L 41/0894; H04L 41/12; H04L 65/1016; H04L 65/1069

(57) ABSTRACT

Various embodiments of the present technology generally relate to systems and methods for providing a binding restoration engine to enable initiation of an IMS-based session in the absence of a respective binding. In an example, the binding restoration engine may determine a lack of a binding for a session created between a network function, such as the Session Management Function (SMF), and a Policy Control Function (PCF). Despite the lack of the binding, the binding restoration engine may accept a subsequently received Rx request to allow the IMS-based session to proceed. Following the acceptance, the binding restoration engine may audit the network to identify the PCF associated with the session, and once identified initiate a binding restoration process at the PCF to recreate the binding for the IMS-based session.

### TECHNICAL FIELD

Various embodiments of the present technology generally relate to network function communication within networks. More specifically, embodiments of the present technology relate to systems and methods for providing a binding restoration engine for enabling initiation of IMS-based sessions in scenarios where the Binding Support Function (BSF) lacks a respective binding for the session.

### BACKGROUND

Communication networks, such as 4G and 5G, have become the backbone of modern communication, revolutionizing how people and devices connect across the globe. These technologies provide the essential infrastructure for high-speed, reliable wireless communication, enabling everything from everyday smartphone use to complex industrial applications. 4G networks laid the foundation by introducing fast data transfer rates and improved mobile internet experiences. Now, with the advent of 5G, the world is witnessing unprecedented advancements in speed, capacity, and low-latency communication, paving the way for transformative applications like autonomous vehicles, smart cities, and the Internet of Things (IoT). These networks collectively form the cornerstone of modern communication, driving innovation and shaping the future of global connectivity.

Within the 5G network, the Binding Support Function (BSF) plays a crucial role in managing binding records, particularly for applications and services that require policy control, such as voice and video calls. As part of its core functionality, the BSF is responsible for maintaining binding information, which links various network sessions, enabling the correct application of policies and charging rules. One of the key functions of the BSF is acting as a Diameter proxy, facilitating the Rx flow between an Application Function (AF) and the Policy Control Function (PCF). In this role, the BSF ensures that Rx requests from the AF are directed toward the appropriate PCF instance or set that holds the corresponding matching binding, often referred to as an N7 session. By doing so, the BSF helps ensure proper policy enforcement and resource allocation for network services, making it a vital component in maintaining the quality and reliability of 5G services.

In some scenarios, however, the BSF may fail to identify a matching binding, leading to critical issues in the handling of service requests. This typically occurs when the PCF is unable to successfully create or update the binding information at the BSF due to network congestion, overload, or communication failures between network components such as the Service Communication Proxy (SCP) or routers. When the BSF is unable to find a corresponding binding for an incoming Rx request, the service—whether it's a voice call, video call, or another application—may fail to proceed, resulting in service disruptions. Such failures can have significant negative outcomes, including degraded customer experience, dropped calls, and interruptions in service continuity. Additionally, the absence of a valid binding can trigger further network stress, as users may attempt to restart or reconnect their devices, generating additional signaling traffic that strains the access and core network, potentially exacerbating the initial problem.

Accordingly, there exists a need for systems and techniques for improved frameworks for addressing scenarios in which the BSF cannot identify a binding for a respective session. In particular, there is a need for a binding restoration engine that enables initiation of an IMS-session despite a lack of a respective binding for the session.

The information provided in this section is presented as background information and serves only to assist in any understanding of the present disclosure. No determination has been made and no assertion is made as to whether any of the above might be applicable as prior art with regard to the present disclosure.

### OVERVIEW

Technology is disclosed herein for systems and techniques for providing a binding restoration engine and one or more of its related functions. As described in greater detail below, the binding restoration engine may enable an IMS-based session to initiate and/or proceed despite a lack of a respective binding for a PCF. For example, the binding restoration engine may accept an Rx request from a network function, such as a Proxy-Call Session Control Function (P-CSCF) despite determining a lack of a corresponding binding, thereby allowing the IMS-based session to be initiated. Responsive to accepting the Rx request, the binding restoration engine may query a Network Repository Function (NRF) to identify a listing of PCFs within the network that may potentially be the respective PCF associated with the on-going session.

Once the binding restoration engine receives a listing of PCFs within the network from the NRF, the binding restoration engine may generate and send a binding retrieval query to a subset of the PCFs in the listing. As described in greater detail below, each of these PCFs may respond and based on their responses, the binding restoration engine may determine the appropriate PCF that is associated with the session. Additionally, the binding restoration engine may cause the PCF to initiate a binding restoration process. As part of the binding restoration process, the PCF may request that the BSF create a binding record for the session, thereby establishing the binding at the BSF. Following creation of the binding record at the BSF, the binding restoration engine may optionally terminate the on-going IMS-based session to recreate the session with the appropriate binding.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

The accompanying drawings, which are incorporated into and constitute a part of this specification, illustrate one or more certain aspects and, together with the description of the example, serve to explain the principles and implementations of the certain examples.

FIG. 1 illustrates an example operational environment for a 5G network in which one or more functions of a binding restoration engine can be implemented, according to an embodiment herein;

FIG. 2 illustrates an example operational flow in which a BSF fails to create a binding record for a corresponding session, according to an embodiment herein;

FIG. 3 illustrates an operational environment 300 including a binding restoration engine, according to an embodiment herein;

FIG. 4 provides an example binding restoration engine process, according to an embodiment herein;

FIG. 5 illustrates an example operational flow for providing one or more functions of a binding restoration engine, according to an embodiment herein;

FIG. 6 provides another example operational flow illustrating a binding restoration engine auditing a network and initiating a binding restoration process, according to an embodiment herein; and

FIG. 7 shows an example computing device suitable for providing a binding restoration engine and its related functions, according to an embodiment herein.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Communication networks like 4G and 5G provide the essential infrastructure for delivering IP Multimedia Subsystem (IMS)-based sessions, which enable multimedia services such as voice, video, and messaging over IP networks using Session Initiation Protocol (SIP) for signaling. An IMS-based session refers to a communication session managed by the IMS framework, allowing seamless access to multimedia services across devices and networks. While 4G introduced the foundation for IMS services with faster data speeds and improved mobile internet experiences, 5G has significantly enhanced the delivery of these sessions by offering higher speeds, greater capacity, and lower latency. This enables high-quality, real-time multimedia services like HD voice and video calls, supporting critical applications in areas such as remote healthcare, augmented reality, and smart cities, as well as improving communication for IoT devices

When an IMS-based session is initiated, the network first establishes an N7 session to handle the communication between the SMF and the PCF. The N7 session is crucial for applying appropriate policy and charging rules to the session. Upon the creation of this N7 session, the BSF plays a key role in managing the session's lifecycle. The BSF identifies and creates a binding initiated by the PCF, that associates the N7 session with the specific policy and charging rules defined for the IMS-based session. This binding ensures that the PCF can be discovered when the IMS session is initiated. Once the BSF verifies the associated binding exists and confirms the PCF identity from the binding session, it authorizes the start of the IMS-based session, ensuring seamless and policy-compliant communication.

In some scenarios, however, the BSF may be unable to identify a binding for a respective IMS-based session. This can occur if there is a mismatch between the session context provided in the IMS session request and the stored binding records, or if no binding has been previously established for that particular session. In such cases, the BSF is unable to associate the session with the necessary PCF which holds the associated N7 Protocol Data Unit (PDU) session, leading to a failure in discovering the PCF for the session. This may happen due to issues like incorrect session parameters, incomplete registration of network functions, or misconfigured policy rules. When the BSF cannot identify a binding, the IMS-based session might either be rejected, delayed until further binding attempts are made, or require manual intervention to resolve the conflict before the session can proceed.

In some scenarios, the BSF may be unable to identify a binding for a respective IMS-based session. Under conventional 5G architectures, the BSF operates without an API for direct interaction or external integration, limiting its communication capabilities to standardized protocols within the 5G core network. This design constraint present under conventional frameworks means the BSF cannot autonomously discover PCFs from the NRF, such as when the BSF cannot find the binding session in its own database; instead, it relies on preconfigured information or signaling from other network components to route traffic to the correct PCF instance for binding management. When the BSF is unable to identify a binding, it could be due to a lack of preconfigured data, mismatched session context, or an incomplete session registration. As a result, the BSF fails to associate the session with the necessary policy and charging rules, preventing authorization of the IMS-based session. This may lead to session rejection, delays, or the need for manual intervention to resolve the issue.

To address at least these issues, an example binding restoration engine and its related functions are provided herein. As will be described in greater detail below, a binding restoration engine may improve upon the conventional IMS-based session framework to allow an IMS-based session to initiate despite a lack of a respective binding. That is, in scenarios where the BSF is unable to identify or create a binding that associates a respective N7 session with the specific policies and rules defined for the IMS-based session, the binding restoration engine may still approve an Rx request to initiate the IMS-based session. By approving the Rx request, the binding restoration engine enables the IMS-based session to proceed.

While the IMS-based session proceeds, the binding restoration engine may audit the network to identify the respective PCF associated with the N7 session. As will be described in greater detail below, once the binding restoration engine identifies the PCF associated with the N7session, the binding restoration engine may cause the PCF to initiate a binding restoration process. Once the binding restoration process is performed, the binding restoration engine may reestablish the IMS-based session to properly link the IMS-based session with the appropriate PCF, thereby ensuring that the correct policies and rules are applied to the session.

By enabling an IMS-based session to proceed, regardless of the absence of a respective binding, the binding restoration engine prevents unnecessary delays in session authorization and reduces the negative outcomes that end-user experience due to session failures. That is, the binding restoration engine reduces the risk of session setup failures, which in turn helps to minimize network congestion caused by repeated attempts to establish sessions. By preventing bottlenecks associated with binding failures, the binding restoration engine allows for higher operational efficiency, reduces manual interventions, and improves the overall reliability and scalability of the network, particularly in high-demand scenarios such as large-scale IoT deployments or real-time multimedia services.

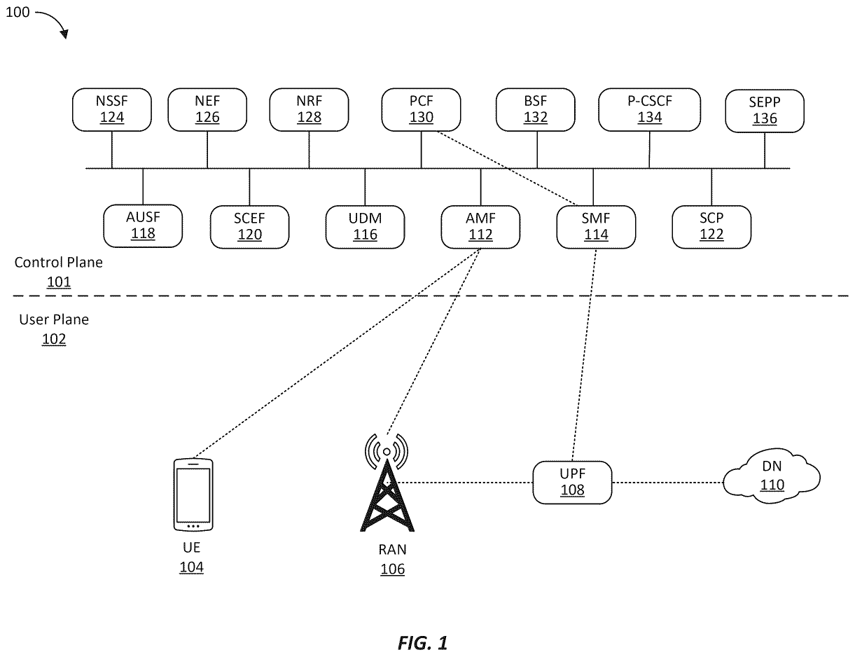

Turning now to the Figures, FIG. 1 illustrates an example operational environment for a 5G network 100 in which one or more features of a binding restoration engine can be implemented, according to an embodiment herein. The example 5G network 100 is a 5G core (5GC) cellular network implementing 3GPP (3rd Generation Partnership Project) communication standards, although the present disclosure may apply to other communication networks. It should be appreciated that while the following discussion focuses on a 5G network, the binding restoration engine may also operate within other communication networks. For example, the binding restoration engine may be employed within a 4G network that is enabled to use 5G resources.

The 5G network 100, its components, and their sub-components may be implemented via computers, servers, hardware and software modules, or other system components. The components of the 5G network 100 and its subcomponents, or the physical devices implementing them, may be co-located, remotely distributed, or any combination thereof. The elements of 5G network 100 may include components hosted or situated in the cloud and implemented as software modules potentially distributed across one or more server devices or other physical components.

The 5G network 100 is divided into two fundamental planes: a control plane 101 and a user plane 102, each serving distinct yet interdependent roles. The control plane 101 is responsible for managing the signaling and control information necessary to establish, modify, and terminate communication sessions. The control plane 101 handles tasks such as authentication, policy enforcement, and mobility management. As such, the control plane 101 is crucial for orchestrating and controlling the NFs, ensuring efficient and secure connectivity. On the other hand, the user plane 102 deals with the actual data transmission—the movement of user data between devices and applications. It is optimized for high-throughput, low-latency data delivery, and is designed to efficiently transport user traffic. The separation of the control plane 101 and user plane 102 in the 5G network 100 enhances scalability, flexibility, and enables network slicing, allowing tailored configurations to meet diverse service requirements. Together, these planes 101 and 102 form a cohesive architecture that empowers the 5G network 100 to deliver unprecedented speed, reliability, and versatility for a wide array of applications and services.

As noted above, the user plane 102 of the 5G network 100 operates in tandem with the control plane 101 to deliver efficient and seamless data transmission. For example, as illustrated, when a User Equipment (UE) 104, which could be a smartphone or any other device, initiates a communication the user plane 102 handles the actual user data traffic. When the UE 104 initiates communication, the Radio Access Network (RAN) 106 comes into play, managing the wireless connection between the UE 104 and the network 100, in particular the UE 104 and the Access and Mobility Management Function (AMF) 112. The RAN 106 acts as the bridge between the user plane 102 and the control plane 101, facilitating the establishment of communication sessions. As data travels through the RAN 106, it encounters the User Plane Function (UPF) 108, which plays a pivotal role in processing and optimizing user data. The UPF 108 is responsible for tasks such as traffic optimization, content caching, and data transformation, enhancing the efficiency of data delivery.

The UPF 108 provides the data to the Data Network (DN) 110, which could represent the broader internet or a specific network service. The DN 110 processes and delivers the user data to its intended destination, completing the journey initiated by the UE 104. The collaborative operation of the user plane 102, UE 104, RAN 106, UPF 108, and DN 110 ensures that data is transmitted reliably and efficiently, meeting the high-performance expectations of 5G networks. As those skilled in the art readily appreciate, the separation of user plane 102 and control plane 101 allows for flexible network configurations and optimizations, contributing to the enhanced capabilities of the 5G ecosystem.

As noted above, when the UE 104 initiates a communication within the 5G network 100, the AMF 112 coordinates the interaction. For example, when the UE 104 initiates communication or moves within the 5G network 100, it sends signaling messages to the AMF 112. The AMF 112 is responsible for tasks such as authentication, authorization, and mobility management. Upon receiving the signaling messages from the UE 104, the AMF 112 validates the user's identity, checks for necessary permissions, and establishes the necessary context for the session. The AMF 112 coordinates with other network functions, such as the Session Management Function (SMF) 114 and the Unified Data Management (UDM) 116, to ensure the seamless setup and management of communication sessions. The interaction with the control plane 101 enables the UE 104 to access network services, adhere to established policies, and maintain continuous connectivity while benefiting from the advanced capabilities and optimizations offered by the 5G network architecture.

The control plane 101 includes example components, nodes, or NFs. As illustrated, the control plane 101 includes the AMF 112, the SMF 114, the UDM 116, an Authentication Server Function (AUSF) 118, an Service Capability Exposure Function (SCEF) 120, Service Communications Proxy (SCP) 122, a Network Slice Selection Function (NSSF) 124, Network Exposure Function (NEF) 126, a Network Repository Function or NF Repository Function (NRF) 128, a Policy Control Function (PCF) 130, a Binding Support Function (BSF) 132, Proxy-Call Session Control Function (P-CSCF) 134, and a Security Edge Protection Proxy (SEPP) 136. The selection of NFs 112-136 depicted in the 5G network 100 is exemplary, and some of the NFs 112-136 may be excluded, or other NFs added to the collection, such as Unified Data Management (UDM) or Unified Data Repository (UDR), without departing from the scope of this disclosure. The various NFs 112-136 execute various operations to provide communication services to UEs, such as the UE 104, that connects to the 5G network 100. A network node or NF that provides service is referred to herein as a Producer NF, while a network node or NF that consumes services is referred herein to as a Consumer NF. A network function can be both a Producer NF and a Consumer NF depending on whether it is consuming or providing service.

The NFs 112-136 of the 5G network 100 exchange various communications in the course of providing network services. The communications may include messaging to establish or end secured communication channels, such as transport layer security (TLS) handshakes, as well as service-based interface (SBI) communications. As used herein, SBI is the term given to the application programming interface (API) based communication that can take place between two NFs within the 5G SBA. A given NF can utilize an API call over the SBI to invoke a particular service or service operation. Communications between NFs 112-136 may be performed over network links and communication channels of the 5G network 100 that are not explicitly depicted in FIG. 1.

When the UE 104 initiates communication within the 5G network 100, various network functions often operate in pairs, where one NF acts as the producer (“the Producer NF”), generating or providing specific services or information, and the other NF acts as the consumer (the “Consumer NF”), utilizing or consuming the produced services or information to complete service requests. For instance, consider the interaction between the SMF 114 and the Policy Control Function (PCF) 130. The SMF 114, as the Consumer NF, initiates service requests related to session establishment, modification, or termination for UE sessions, such as for the UE 104. The SMF 114 communicates these requests to the PCF 130, acting as the Producer NF, which performs functions related to session management, Quality of Service (QoS) enforcement, and access control. The PCF 130 processes the requests from the SMF 114, enforces QoS policies, manages session establishment and modification, and ensures appropriate access control based on network policies and conditions. Through this producer-consumer interaction, the SMF 114 and PCF 130 collaborate to deliver efficient and reliable service within the 5G network architecture.

As those skilled in the art readily appreciate, various NFs may act as producer NFs and consumer NFs. For example, a producer NF may be or include the PCF 130, the SMF 114, the UDR (not shown), a charging function (CHF), BSF 132) or a Network Data Analytic Function (NWDAF) (not shown). depending on the operation and the service request. A consumer NF may be or include the UE 104, a Service Capability Exposure Function SCEF 120, the SCP 122, the SMF 114, the AMF 112, the NEF 126, a security edge protection proxy (SEPP) 136, the UDR, or a charging function (CHF), depending on the operation and the service request.

As noted above, the 5G network 100 includes the SEPP 136. The SEPP 136 plays a crucial role in enhancing the security framework of the 5G network 100. For example, the SEPP 136 may act as a gateway between the 5G core network 100 and external networks, such as a visitor network, or service providers, thereby ensuring that all data exchanges are secure and compliant with the latest security protocols. It protects against unauthorized access and potential threats by encrypting and decrypting signaling messages, thereby safeguarding the integrity and confidentiality of communications. By monitoring and filtering traffic at the network edge, the SEPP 136 also helps in detecting and mitigating various cyber threats, ensuring robust protection for the 5G network's 100 expansive and dynamic infrastructure.

The network 100 may support IMS-based sessions, such as voice over LTE, video calls, or real-time text messaging. As such, to initiate an IMS-based session the UE 104 sends a session request to the SMF 114, which is responsible for managing the data plane connection. The SMF 114, in turn, communicates with the PCF 130 to retrieve the appropriate policy and QoS parameters that will govern the session. The PCF 130 determines the session's QoS parameters, such as bandwidth and priority, ensuring that the session adheres to the network's 100 policy and regulatory constraints. Once the SMF 114 and PCF 130 establish the required QoS through the N7 interface, the data session is set up.

Once the N7 session is established between the SMF 114 and the PCF 130, the BSF 132 is invoked to bind the PCF 130 to the IMS-based session. The BSF 132 works alongside the P-CSCF 134, which handles the initial signaling for the IMS-based session. The P-CSCF 134, as the first point of contact within the IMS, processes the signaling requests from the UE 104, including session initiation and routing. That is, the P-CSCF 134 secures the signaling and forwards the session request to the appropriate IMS core components, enabling the video call to be established between the UE 104 and the intended recipient.

In some situations, however, conditions arise where the transition of session control from the N7 interface (between SMF 114 and PCF 130) to the IMS components is disrupted. For instance, if the BSF 132 is unable to identify or establish the correct binding for the N7 session, the BSF 132 may fail to authenticate or bind the session tokens. This disruption in the authentication and binding process can result in the UE 104 being unable to securely establish an IMS-based session. Without the proper binding, the signaling between the UE 104 and the network 100 cannot be established, leading to session rejection or failure. As can be appreciated, session rejection or failure typically negatively affects the user experience by causing service interruptions, call drops, or lower-quality service, undermining the reliability and user experience that IMS-based sessions are designed to provide.

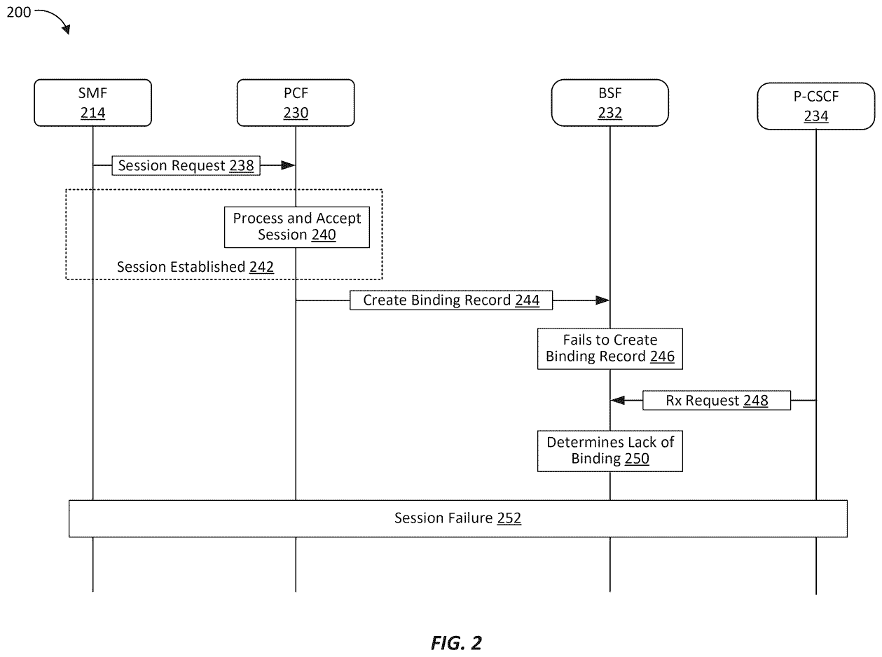

Referring now to FIG. 2, an example operational flow 200 in which a BSF 232, which may be the same or similar to the BSF 132, fails to create a binding record for a corresponding session is illustrated, according to an embodiment herein. For ease of illustration, FIG. 2 is described in the context of a 5G network environment, such as the 5G network 100, however, it should be appreciated that the following is equally applicable to other networks, such as a 4G network utilizing 5G network functions.

As illustrated, an SMF 214, acting as an NF consumer, may establish an N7 session with the PCF 230 to initiate an IMS-based session on behalf of the end user, such as the UE 104. The SMF 214, which may be the same or similar to the SMF 114, may send a session request to the PCF 230 to establish the N7 session (238). The session request may include various information about the IMS-based session being requested, such as specifying the type of IMS-based session, the required QoS parameters, and the relevant user-specific details. It should be appreciated, that while the following discussion focuses on the SMF 214 establishing an N7 session with the PCF 230, in other embodiments, an AMF may interact with the PCF 130 over an interface, such as an N15 interface or the AF may interact with the PCF 130 to over an interface, such as an N5 interface to retrieve and apply policies. The following discussion is equally applicable to these scenarios.

Upon receiving the session request, the PCF 230 may process and accept the request (240). For example, the PCF 230 may process the request by verifying the QoS parameters, checking the user's subscription, and evaluating the network's policy rules. The PCF 230 may also assess whether the network can accommodate the session based on current traffic, resource availability, and predefined policies. If these conditions are satisfied, the PCF 230 accepts the session request, generates the necessary policy rules, and send an acceptance message back to the SMF 214. This acceptance might include all the policies and QoS controls required for the IMS session. As illustrated, after the PCF 230 accepts the request, a session is established between the SMF 214 and the PCF 230, such as an N7 session (242).

Once the session between the SMF 214 and the PCF 230 is established, the IMS-based session with the IMS components may proceed, such as triggering signaling to a P-CSCF 234, which may be the same or similar to the P-CSCF 134. The P-CSCF 234 processes the signaling request from the SMF 214 and coordinates with other IMS components, such as the Serving CSCF (S-CSCF) and the Interrogating CSCF (I-CSCF), to manage the session setup and routing. To initiate the IMS-based session, the P-CSCF 234 interacts with the BSF 232, which is responsible for managing authentication tokens and binding them to the session. This binding ensures that the IMS-based session is securely linked to the policies defined by the PCF 230, allowing the session to proceed with the appropriate QoS and policy enforcement.

As noted above the BSF 232 manages the binding of the PCF 230 to a respective IMS-based session by acting as a middle-man between the PCF 230 and the P-CSCF 234. For example, responsive to establishing the session with the SMF 214, the PCF 230 sends a request to create a binding record to the BSF 232 (244). This request may contain information related to the IMS-based session, such as the session identifiers, user-specific details, and policy rules that need to be enforced during the session. The request also instructs the BSF 232 to create a secure binding between the IMS-based session, which may be part of the request from the PCF 230, that will be used to validate and manage the session.

Upon receiving the request from the PCF 230, the BSF 232 may process the information to generate a unique binding record. This binding record links the session's identity and policy rules with the IMS components to authorize and validate the IMS-based session as it progresses. The BSF 232 uses the binding record associated with the IMS-based session to ensure that the correct policy control data is applied to the IMS session, enabling seamless enforcement of policies across different network elements during the session.

However, in some scenarios, the BSF may fail to create the requested binding record (246). For example, the BSF may not receive the “create binding record” request from the PCF 230 due to network congestion, signaling delays, or temporary communication breakdowns within the network infrastructure. Such disruptions could occur when there is a high volume of traffic or when network nodes experience latency issues, causing the request to be delayed or lost. In another example, the BSF may receive the request but fail to create the binding record due to internal processing errors or resource limitations. These failures could stem from issues like system overload, insufficient memory, software glitches, or misconfigured parameters that prevent the BSF from processing the request properly. In both cases, the BSF's inability to create the binding record impacts the subsequent stages of IMS-based session establishment, such as described below.

As illustrated, subsequent to the PCF 230 requesting the creation of a binding record, the P-CSCF 234 may transmit an Rx request, such as an AAR-I (Authorization and Authentication Request-Initial), to the BSF 232 (248). The Rx request is a signaling message used by the P-CSCF 234 to query the BSF 232 for binding and authentication information related to the IMS session, ensuring that the IMS-based session is properly authorized and securely linked to the user's identity and the policy rules set by the PCF 230. This request is crucial in confirming that the IMS-based session adheres to the policies and authentication established during the earlier stages of session setup.

In response to receiving the Rx request, the BSF 232 may attempt to determine the respective binding based on the session details provided in the Rx request, such as session identifiers or user-specific information. The BSF 232 processes this information and searches for the binding record that should have been created when the PCF 230 previously sent the “create binding record” request. However, in the illustrated example, the BSF 232 is unable to identify the binding record and determines a lack of binding for the IMS-based session associated with the Rx request (250). As noted above, the lack of binding at the BSF 232 may occur due to several reasons, such as the binding record not being created successfully earlier, a mismatch in session identifiers, or a failure in the BSF's internal record management system. As a result, the BSF 232 cannot provide the necessary authentication and policy information back to the P-CSCF 234.

If the BSF 232 cannot identify the binding associated with the session related to the Rx request, the P-CSCF 234 is unable to proceed with coordinating the initiation of the IMS-based session. Since the binding record contains crucial information, such as the authentication tokens and policy rules, that ensure the session is properly authorized and securely linked to the user's identity, the P-CSCF cannot verify the session's legitimacy or enforce the necessary QoS parameters as dictated by the PCF 230. As a result, the P-CSCF 234 is forced to halt the session initiation process, which can lead to session failure or significant disruption (252). For the end-user, this means that the intended IMS-based service, such as a voice or video call, may fail to start, be delayed, or be unexpectedly interrupted, ultimately degrading the quality of experience and trust in the network's reliability.

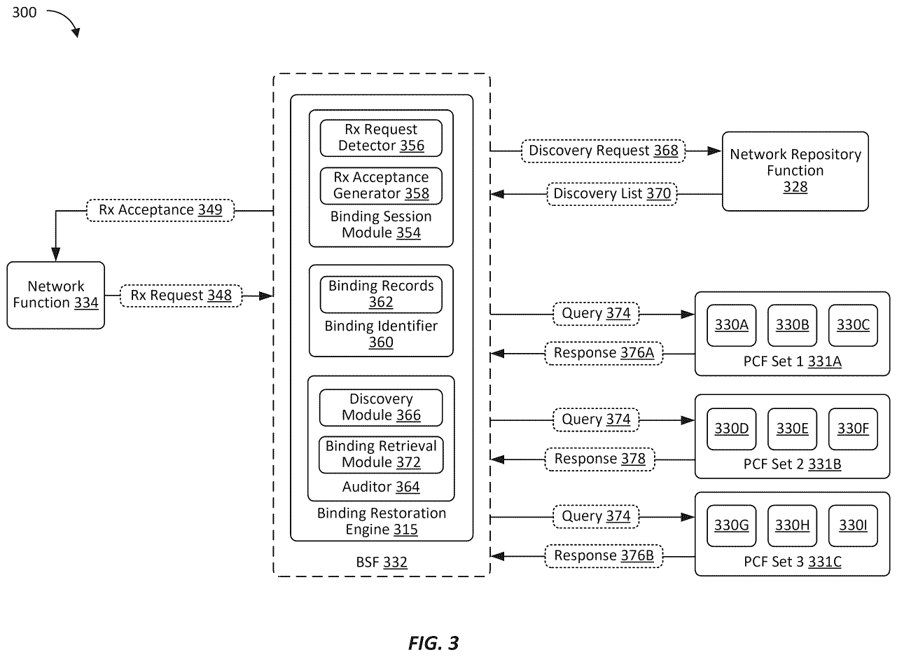

To address at least the above shortcomings of conventional binding frameworks and enable IMS-based sessions to proceed despite the absence of a respective binding record, an example binding restoration engine is provided herein. Referring now to FIG. 3, an operational environment 300 including a binding restoration engine 315 is illustrated, according to an embodiment herein. As shown, the binding restoration engine 315 may be part of a BSF 332, which may be the same or similar to the BSF 232. It should be appreciated, that while the following discussion is focused on the illustrated arrangement of the binding restoration engine 315, in some embodiments, one or more of the illustrated components/functions of the binding restoration engine 315 may be arranged differently. For example, in some embodiments, the binding restoration engine 315 may be hosted separately from the BSF 332, such as by a third party or another NF.

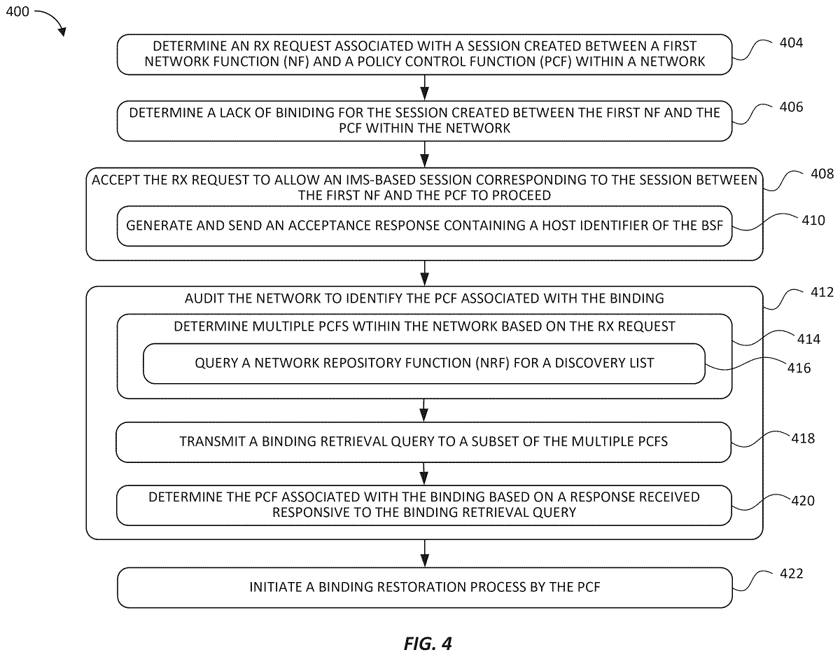

For ease of explanation, FIG. 3 is described in conjunction with FIG. 4, which provides an example binding restoration engine process, in particular a process 400 for providing the binding restoration engine 315 and one or more of its functions, according to an embodiment herein. In other words, FIG. 4 illustrates the process 400 for enabling initiation of an IMS-based session in the absence of a respective binding, according to an embodiment herein. While FIG. 4 is described with relation to FIG. 3, it should be appreciated that components, elements, and steps from any other Figures described herein may be equally applicable.

In the illustrated example, the BSF 332 may act as a Diameter proxy, handling the flow of Rx signaling messages between a network function 334, such as the P-CSCF 234, and a respective PCF instance responsible for managing an IMS-based session. In such scenarios, the BSF 332 may receive an Rx request 348 from the network function 334 and in turn (once it identifies the associated PCF) forward the Rx signaling to the correct PCF instance (or set) that has an established binding for the ongoing IMS-based session. For example, when the P-CSCF 234 needs to request policy and QoS rules for an IMS-based session, the Rx request 348 may be an AAR-I communication.

Responsive to the BSF 332 receiving the Rx request 348, the binding restoration engine 315 may determine that the Rx request 348 is received (404). That is, the binding restoration engine 315 may include a binding session module 354 containing an Rx request detector 356 that may receive an indication when the BSF 332 receives the Rx request 348. The Rx request 348 may be associated with a session created between a first network function (NF) and a PCF 130 within the network 100, such as an N7 session created between the SMF 114 and the PCF 130.

Responsive to detecting the Rx request 348, the binding restoration engine 315 may determine a lack of a binding for the session created between the first NF and the PCF 130 within the network 100 (406). In particular, the binding restoration engine 315 may include a binding identifier 360 that may query binding records 362 previously created by the BSF 332 to determine whether or not there is a binding record associated with the information provided in the Rx request 348. For example, if the Rx request 348 is an AAR-I request from the P-CSCF 134, the Rx request 348 may include various information about the IMS-based session. This information may include Session Identifiers (Session-ID), user identity, such as IMSI (International Mobile Subscriber Identity), IMPI (IP Multimedia Private Identity), or IMPU (IP Multimedia Public Identity), service information about the IMS service being requested, and details on the QoS requirements. Using information from the Rx request 348, the binding identifier 360 may query the binding records 362 for a matching binding record. However, in the illustrated example, the BSF 332 cannot find a matching binding or session. As such, the BSF 332 (when acting as a Diameter proxy) cannot forward the Rx request 348 properly, which could result in a delay or failure in IMS-based session initiation for the end user.

To enable the IMS-based session to initiate or proceed, despite the lack of a binding record, the binding restoration engine 315 may accept the Rx request 348 (408). In some embodiments, acceptance of the Rx request 348 by the binding restoration engine 315 may be based on the operator criteria and configuration as provided in or associated with the Rx request 348. That is, operator criteria may indicate that the binding restoration engine 315 should automatically accept the Rx request 348 based on various criteria, such as session types, while in other embodiments, the operator criteria may indicate that the binding restoration engine 315 should refrain from accepting the Rx request 348. Based on this information, the binding restoration engine 315 may determine whether or not to accept the Rx request 348. Responsive to receiving the Rx request 348, the binding restoration engine 315 may store the Rx request 348 and/or the information included in the Rx request 348 for use in subsequent steps.

In some embodiments, to accept the Rx request 348, the binding restoration engine may generate an acceptance response 349 to the Rx request 348 (410). In particular, the binding session module 354 of the binding restoration engine 315 may include an Rx acceptance generator 358 that generates the acceptance response 349. Following the above example where the Rx request 348 is an AAR-I request from the P-CSCF 234, the acceptance response 349 may be an Authentication, Authorization, and Accounting (AAA) response. As part of the acceptance response 349, Rx acceptance generator 358 may include a host identifier that identifies the BSF 332 as the network element/function responsible for managing or processing the IMS-based session. As can be appreciated, typically, the host identifier would indicate the specific PCF for handling the IMS-based session as identified by the binding. However, since the binding restoration engine 315 cannot identify the binding, and thus the appropriate PCF to route the IMS-based session signaling to, the binding restoration engine 315 indicates that the BSF 332 is to handle the IMS-based session signaling.

In some embodiments, the Rx acceptance generator 358 may also generate one or more configurable attributes within the acceptance response 349. The configurable attributes may provide criteria or information for the network function 334 to fill in the required Attribute-Value-Pairs (AVPs). In some embodiments, these configurable attributes may be generated based on the information from the Rx request 348, such as the operator criteria and/or configurations. Once generated, the binding restoration engine 315, via the BSF 332, may send the acceptance response 349 back to the network function 334.

By sending the acceptance response 349 back to the network function 334, the binding restoration engine 315 enables initiation of the IMS-based session or enables the IMS-based session to proceed, despite the absence of a respective binding. Responsive to the BSF 332 sending the acceptance response 349, the associated IMS-based session may be handled over to a “default bearer” and without any policy evaluation/enforcement through the PCF, since the PCF is not reachable by the BSF 332. As such the IMS-based session may experience reduced quality, but may still proceed, thereby providing an improved user experience over the conventional approach of service disruption or failure.

Moreover, once the binding restoration engine 315 indicates that the BSF 332 should accept the Rx request 348, the binding restoration engine 315 proceeds to restore the binding and identify the appropriate PCF for managing the IMS-based session. Often, by the time that the IMS-based session is initiated with the UE 104, the binding is restored and the correct PCF identified for handling the session. As such, the reduced quality of having a default bearer for the IMS-based session experienced by the UE 104 may be minimal and substantially less impactful than the session disruptions experienced under the conventional binding framework. It should be appreciated that while the term “restore” is used herein to describe how the binding restoration engine 315 initiates creation of a new binding for the IMS-based session, this term encompasses both the initial creation of a binding, such as in scenarios where the BSF 332 never received the request from the PCF to create the binding record, and subsequently created binding, such as in scenarios where the BSF 332 initially created a binding but was unable to identify responsive to the Rx request 348.

To restore the binding for the IMS-based session, the binding restoration engine 315 may audit the network to identify the PCF associated with the binding or the IMS-based session (412). To audit the network, the binding restoration engine 315 may include an auditor 364 containing a discovery module 366 and a binding retrieval module 372. At the start of the audit process, the auditor 364 may determine or identify one or more PCFs within the network based on the Rx request 348 (414). In particular, the discovery module 366 may query a network repository function (NRF) 328 to discover one or more PCFs meeting various PCF parameters (416).

To query the NRF 328, the discovery module 366 may generate a discovery request 368. The discovery request 368 may include a request for PCFs within the network that meet one or more PCF parameters. The PCF parameters may include NFType, preferred-locality, Service-name, and/or supportedVendorSpecificFeatures. The PCF parameters may be parsed or otherwise identified by the binding restoration engine 315 based on the configuration of the binding restoration engine 315. In some embodiments, the PCF parameters may be provided by an operator or be default values based on the configuration of the CSF 332. Once identified, the discovery module 366 generates the discovery request 368 to include a request for PCFs within the network 100 that meet the NF parameters. The discovery request 368 is then sent to the NRF 428.

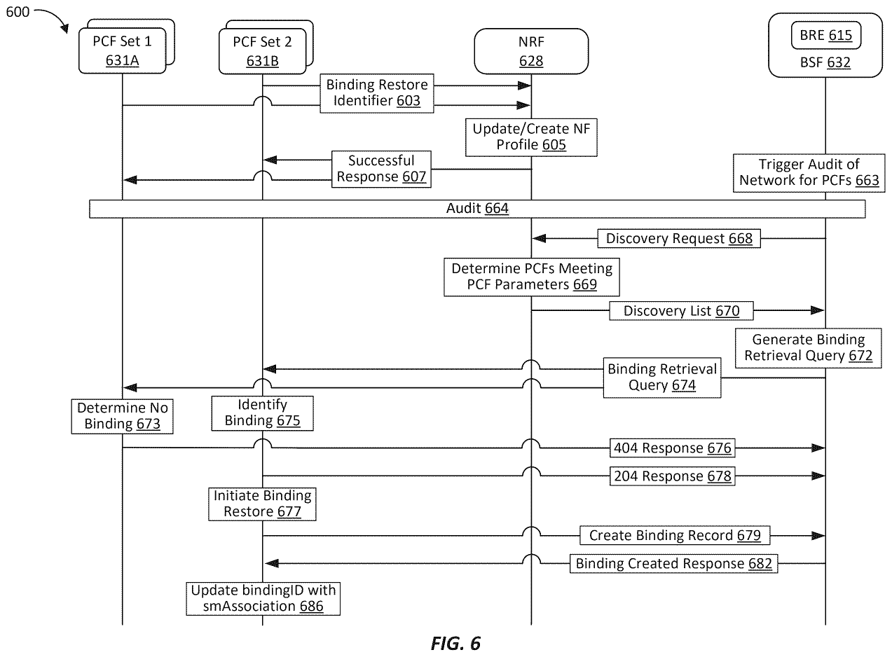

Responsive to receiving the discovery request 368, the NRF 328 may identify PCFs within the network 100 meeting the PCF parameters. For example, NRF 328 may query the NF profiles for each PCF within the network to identify PCFs that meet the requested PCF parameters. As those skilled in the art readily appreciate, the NF profile for each PF generally includes key attributes for that PCF, such as NFType, supported services, geographical locality, and capacity. As will be described in greater detail below with respect to FIG. 6, according to the present disclosure, the PCFs may also register in the NRF 328 with a binding restore identifier. The binding restore identifier may be stored within a respective PCF's NF profile at the NRF 328. As will be described below, the binding restore identifier may allow the binding restoration engine 315 to identify the appropriate PCF for a given IMS-based session.

Once the NRF 328 identifies the PCFs meeting the PCF parameters, the NRF 328 may generate and send a discovery list 370 to the binding restoration engine 315 (via the BSF 332). The discovery list 370 may identify the PCFs, such as the PCFs 330A-I, which meet the PCF parameters listed in the discovery request 368. Responsive to receiving the discovery list 370, the auditor 364 of the binding restoration engine 315 may generate a binding retrieval query 374. In particular, the binding retrieval module 372 of the auditor 364 may generate the binding retrieval query 374 to query one or more of the PCFs 330A-I identified in the discovery list 370.

It should be appreciated that while PCFS 330A-I are illustrated, any number of PCFs may be identified by the NRF 328. Similarly, while the PCFs 330A-I are part of PCF sets 331A-C, the PCFS 330A-I may be part of any number of PCF sets or not part of a PCF set at all.

In some embodiments, the binding retrieval query may be a GET request containing an apiRoot, such as a custom HTTP operation GET at Npcf_SMPolicyControlService. In an example, the binding retrieval query may also include query parameters, such as a UE address, subscription permanent identifier (SUPI) or generic public subscription identifier (GPSI), DNN, Single Network Slice Selection Assistance Information (S-NSSAI), and/or IPv4 address domain. One or more of these query parameters may be parsed from the Rx request 348, which as noted above, may be stored by the binding restoration engine 315. An example binding retrieval query 374 that may be used to audit the network by the binding restoration engine 315 is as follows: {apiRoot}/npcf-smpolicycontrol/v1/sm-policies? <query_parameters>. In some embodiments, the binding retrieval query 374 may include a custom header requesting that a respective PCF respond to the binding restoration engine 315 if “bindingRestore =True.”

As illustrated, once the binding retrieval query 374 is generated, the binding restoration engine 315 may transmit the binding retrieval query 374 to a subset of the PCFs identified in the discovery list 370 (418). In some embodiments, the binding retrieval query 374 may only be sent to a subset of PCFs because, as illustrated, the PCFs 330A-I identified in the discovery list 370 may be part of one or more PCF sets 331A-C. As such, to avoid race conditions and/or reduce network congestion, the binding restoration engine 315 may select one PCF within each PCF set 331A-C to send the binding retrieval query 374. In some embodiments, the binding restoration engine 315 may select a PCF within a respective PCF set 331A-C based on the priority of the PCF.

Responsive to receiving the binding retrieval query 374, each PCF or PCF set 331A-C may determine that the BSF 332 does not possess the binding for the session associated with the query parameters included in the query 374. Each PCF may check to determine if it owns a session or is associated with a session matching the query parameters. PCFs, such as the PCFs 330A-C and 330G-I within the PCF sets 331A and 331C, may determine that they are not associated with any session matching the query parameters. As such, the receiving PCF within each PCF set 331A and 331C may transmit a response 376A-B back to the binding restoration engine 315. The response 376A-B may be a 404 or notFound response indicating that the respective PCF set 331A and 331C are not associated with the session identified by the query parameters. The PCF sets 331A and 331C may take no further action after sending the responses 376A-B.

In the illustrated example, one of the PCFs 330D-F, such as PCF 330D for ease of explanation, may be the appropriate PCF to associate with the IMS-based session and as such may transmit a response 378 back to the binding restoration engine 315. That is, the PCF 330D may determine that it is associated with a session, such as the N7 or PDU (protocol Data Unit) session meeting the query parameters. As such, the PCF 330D may respond with the response 378 indicating that it owns the respective session. In an example, the response 378 may be a 204 response that contains no content. Based on the responses 376A-B and 378 received from the PCF sets 331A-B, the binding restoration engine 315 may determine the PCF associated with the binding (420).

In addition to determining the appropriate PCF associated with the IMS-based session, the binding restoration engine 315 may initiate a binding restoration process by the respective PCF (422). For example, responsive to receiving the binding retrieval query 374, the PCF, such as the PCF 330D, owning the respective session may initiate a binding restoration process to recreate the binding record again. In an example, the binding retrieval query 374 may be a custom query, such as “registerIfFound” that causes the PCF to initiate the binding restoration process responsive to finding the respective binding for the associated session. As noted above, responsive to receiving the binding retrieval query 374, the PCF 330D may determine that the BSF 332 does not have the binding record for the associated session. As such, the binding retrieval query 374 may cause the PCF 330D to start a BSF binding process for the session again. In an example, the PCF 330D may invoke a Nbsf_Management_Register Service Operation and subsequently send the BSF 332 a request to recreate the binding for the session. As will be described in greater detail below, the request to recreate the binding may be or include an HTTP Post request. An example request is as follows: {apiRoot}/nbsf-management/v1/pcfBindings as Resource URI representing the “PCF Session Bindings.” This example request can allow the PCF 330D to use the BSF's 332 API and URI to restore the binding at the BSF 332, as the PCF 330D should have done at the initial binding creation.

Responsive to receiving the request from the appropriate PCF, here the PCF 330D, to recreate the binding for the session, the BSF 332 may successfully create the binding record for the session. In some embodiments, the BSF 332 may trigger termination of the session by the P-CSCF to cause a new IMS-based session, containing the same UEIP address and DNN/APN parameters as the initial session, to be created. That is, an operator or user may opt to terminate the on-going session to create a new IMS-based session. Responsive to creation of the new IMS-based session, the BSF 332 may proxy the associated Rx request to the correct PCF and the IMS-based session can proceed from the PCF moving forward.

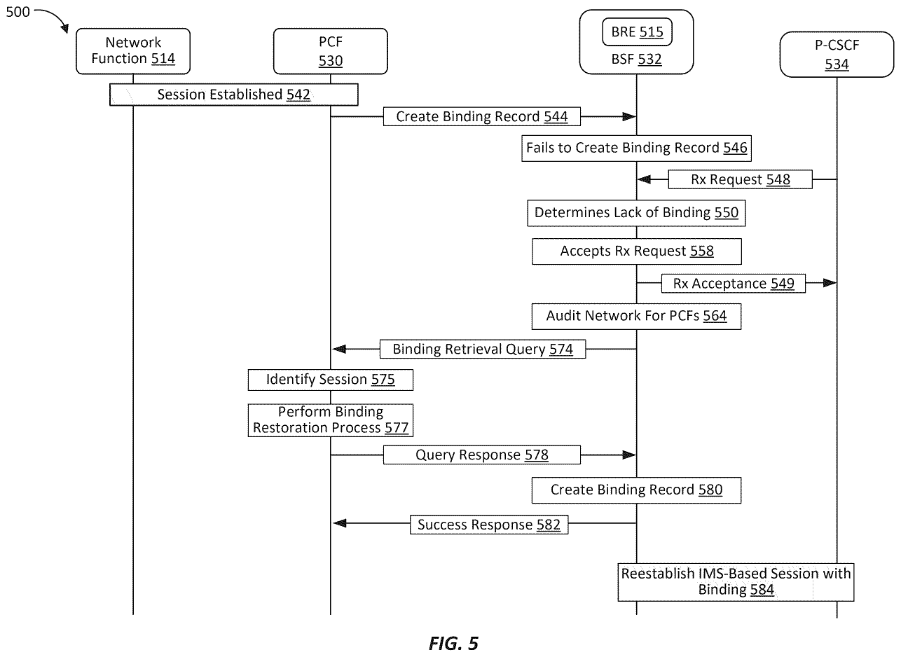

Turning now to FIG. 5, an example flow 500 for performing one or more functions of a binding restoration engine (BRE) 515 is illustrated, according to an embodiment herein. As illustrated, the flow 500 may initiate with a network function 514, which may be the SMF 114, establishing a session, such as an N7 session, with a PCF 530, which may be the same or similar to the PCF 130 (542). Responsive to establishing the session, the PCF 530 may transmit a request to create a binding record to a BSF 532, which may be the same or similar to the BSF 332 (544). The BSF 532 may fail to create the binding record for the session (546) due to a variety of reasons, such as not receiving the request from the PCF 530 due to network congestion.

At a subsequent time to the PCF 530 sending the create binding record request, a P-CSCF 534 may transmit a Rx request to the BSF 532 (548). As noted above, the Rx request may include an AAR-I request, requiring the binding record to be routed to the PCF 530. However, because the binding record was not created by the BSF 532, the binding restoration engine 515 may be leveraged to enable the IMS-based session to continue despite the lack of a binding record.

Responsive to receiving the Rx request 548, the binding restoration engine 515 may determine the lack of binding for the session identified in the Rx request 548 (550). Regardless, the binding restoration engine 515 may accept the Rx request (558) and transmit an Rx acceptance response (549) to the P-CSCF 534. As noted above, in some embodiments, the Rx acceptance response may include an origin identifier identifying the BSF 532, such that subsequent communication from the P-CSCF 534 is routed to the BSF 532. Once the BSF 532 accepts the Rx request, the IMS-based session may be allowed to proceed for a respective UE and desired recipient.

After accepting the Rx request, the binding restoration engine 515 may audit the network for the PCF associated with the session (564). As described above, this may include querying an NRF, such as the NRF 328 to identify PCFs meeting the PCF parameters generated from the Rx request. Since the PCF 530 is the PCF associated with the session, the PCF 530 may be included in the PCFs identified by the NRF as meeting the PCF parameters. As such, when the binding restoration engine 515 generates and sends the binding retrieval query (574) to one or more of the PCFs in the network, the PCF 530 may receive the binding retrieval query as well.

Since the PCF 530 is the PCF associated with the session, the PCF 530 may determine or identify that it owns or is associated with a session matching one or more query parameters identified in the binding retrieval query (575). Responsive to determining the matching session, the PCF 530 may initiate a binding restoration process (577). Simultaneously or sequentially, the PCF 530 may generate and send a query response to the BSF 532 (578) indicating that it is the appropriate PCF associated with the session. In some cases, the query response or a subsequent response may include a request to create a binding record for the session again. As such, responsive to receiving the query response, the BSF 532 may create the binding record for the session (580) and return a success response to the PCF 530 (582).

Once the binding record for the session is created by the BSF 532, the binding restoration engine 515 may cause the BSF 532 to reestablish the IMS-based session with the binding (584). As noted above, this may include responding to any subsequent update requests received from the P-CSCF 534 with a termination response, such as an Abort Session Request (ASR) response to trigger termination of the on-going session. Responsive to termination of the session, a new IMS-based session may be initiated and the flow 500 may continue with the BSF accurately identifying the binding for the new IMS-based session such that the PCF 530 can enforce required policies and configurations on the session.

Referring now to FIG. 6, an example flow 600 illustrated one or more functions of the binding restoration engine 615 to audit the network and initiate a binding restoration process, according to an embodiment herein. As illustrated, the flow 600 may start with one or more PCF sets 631A-631B registering a binding restore identifier (603) with a NRF 328, which may be the same or similar to the NRF 328. Responsive to receiving the communication from each PCF within the PCF sets 631A-B, the NRF 628 may update/create an NF profile for each PCF to include the binding restore identifier. In some cases, the binding restore identifier may be updated within the supportedVendorSpecificFeatures category of the NF profile. As described here, the binding restore identifier may be used by the BSF 632 to identify which PCFs 631A-B support a respective functionality. Responsive to each NF profile being updated with the binding restore identifier, the NRF 628 may transmit a successful response (607) back to each PCF that requested the registration.

At some point after the binding restore identifier is registered with the NRF 328, an audit may be triggered at the BSF 632 (663). For example, the BSF 632 may receive a request from the P-CSCF 134 and the binding restoration engine 615 may determine a lack of a respective binding for the request. As such, the binding restoration engine 615 may audit the network to discover the appropriate PCF associated with the session (664).

To audit the network, the binding restoration engine 615, via the BSF 632, may generate and transmit a discovery request to the NRF 628 (668). As described above, the discovery request may include one or more PCF parameters based on the request initiating the audit. The PCF parameters may help the NRF 628 identify PCFs matching or meeting these requirements, thereby limiting the amount of PCFs “discovered” during the audit. As shown, responsive to the discovery request, the NRF 628 may determine PCFs meeting the PCF parameters (669) and transmit a discovery list back to the BSF 632 (670). The discovery list may include a listing of PCFs that meet the PCF parameters.

Because the binding restoration engine 615 does not know which of the PCFs identified in the discovery list is the correct PCF associated with the session, the binding restoration engine 615 may generate a binding retrieval query (672). The binding retrieval query may include various query parameters associated with the session as identified in the instigating request. Once generated, the binding restoration engine 615 may transmit the binding retrieval query 674 to one or more of the PCFs identified in the discovery list. For example, the binding restoration engine 615 may send the binding retrieval query to one PCF within each of the PCF sets 631A-B, such as the PCF having the highest priority.

Responsive to receiving the binding retrieval query, each PCF set 631A-B may determine whether or not it is associated with the respective session. For example, the PCF set 631A may determine that no PCF within its set is associated with a session matching the query parameters (673). For example, the PCF set 631A may determine that it does not have the binding associated with the session. Responsively, one of the PCFs within the PCF set 631A may transmit a 404 response to the BSF 632 (676). The 404 response may be a notFound response and the PCFs within the PCF set 631A may take no further action.

In contrast, the PCF set 631B may determine that it is associated or owns a session matching the query parameters identified in the binding retrieval query (675). As such, one of the PCFs within the PCF sets 631B may identify the binding and transmit a 204 response to the BSF 632 (678). The 204 response may be a success response indicating that it is associated with the session but may contain no content. As noted above, the PCF corresponding to the session may be triggered to initiate a binding restoration process responsive to receiving the binding retrieval query (677). As such, the PCF within the PCF set 631B may transmit a request to create a binding record to the BSF 632 (679), to which the BSF 632 may responsively generate the binding record. Once generated, the BSF 632 may transmit a binding created response back to the PCF set 631B (682). Based on the binding created response, the PCF managing the session within the PCF set 631B may update a bindingID within the smAssociation (686) such that it can handle the IMS-based session moving forward.

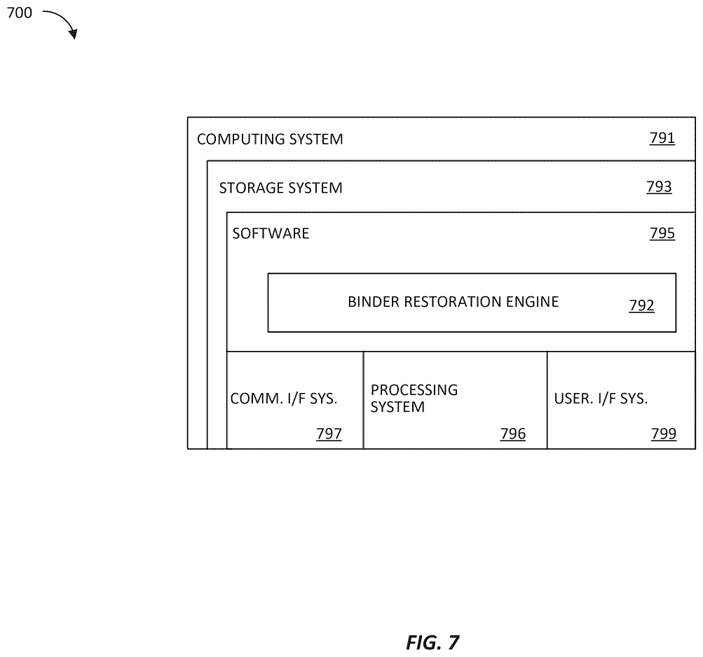

Referring now to FIG. 7, is a diagram of a system 700 configured to implement a binding restoration engine, according to an embodiment herein. The system 700 may be an example of an apparatus including a computing apparatus 791 that is representative of any system or collection of systems in which the various processes, systems, programs, services, and scenarios disclosed herein may be implemented. For example, computing apparatus 791 may be an example binding restoration engine, such as the binding restoration engine 315/515/615, a BSF, such as the BSF 332/532/632, or any of the subcomponents depicted in the 5G network, 100, operational flows 400, 500, or 600, or the operational environment 300 of FIG. 3, respectively. Examples of computing apparatus 791 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing apparatus 791 may be implemented as a single apparatus, system, or device or may be implemented in a distributed manner as multiple apparatuses, systems, or devices. Computing apparatus 791 may include, but is not limited to, processing system 796, storage system 793, software 795, communication interface system 797, and user interface system 799. Processing system 796 may be operatively coupled with storage system 793, communication interface system 797, and user interface system 799.

Processing system 796 may load and execute software 795 from storage system 793. Software 795 may include a binding restoration engine 792, which may be representative of any of the operations for providing a binding restoration engine or any of its related functions, as discussed with respect to the preceding figures. When executed by processing system 796, software 795 may direct processing system 796 to operate as described herein for at least the various processes, such as the process 400 or any of the operational flows 500-600, operational scenarios, and sequences discussed in the foregoing implementations. Computing apparatus 791 may optionally include additional devices, features, or functionality not discussed for purposes of brevity.

In some embodiments, processing system 796 may comprise a micro-processor and other circuitry that retrieves and executes software 795 from storage system 793. Processing system 796 may be implemented within a single processing device but may also be distributed across multiple processing devices or sub-systems that cooperate in executing program instructions. Examples of processing system 796 may include general purpose central processing units, graphical processing units, application specific processors, and logic devices, as well as any other type of processing device, combinations, or variations thereof.

Storage system 793 may comprise any memory device or computer-readable storage medium readable by processing system 796 and capable of storing software 795. Storage system 793 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer-readable storage medium a propagated signal.

In addition to computer-readable storage medium, in some implementations storage system 793 may also include computer readable communication media over which at least some of software 795 may be communicated internally or externally. Storage system 793 may be implemented as a single storage device but may also be implemented across multiple storage devices or sub-systems co-located or distributed relative to each other. Storage system 793 may comprise additional elements, such as a controller, capable of communicating with processing system 796 or possibly other systems.

Software 795 (including the binding restoration engine 792 among other functions) may be implemented in program instructions that may, when executed by processing system 796, direct processing system 796 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 795 may include additional processes, programs, or components, such as operating system software, virtualization software, or other application software. Software 795 may also comprise firmware or some other form of machine-readable processing instructions executable by processing system 796.

In general, software 795 may, when loaded into processing system 796 and executed, transform a suitable apparatus, system, or device (of which computing apparatus 791 is representative) overall from a general-purpose computing system into a special-purpose computing system as described herein. Indeed, encoding software 795 on storage system 793 may transform the physical structure of storage system 793. The specific transformation of the physical structure may depend on various factors in different implementations of this description. Examples of such factors may include, but are not limited to, the technology used to implement the storage media of storage system 793 and whether the computer-storage media are characterized as primary or secondary storage, as well as other factors.

For example, if the computer-readable storage medium is implemented as semiconductor-based memory, software 795 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 797 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between the computing apparatus 791 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable medium(s) having computer readable program code embodied thereon.

The foregoing examples and descriptions are described herein in the context of systems and methods for providing a binding restoration engine or one or more of its related functions. Those of ordinary skill in the art will realize that these descriptions are illustrative only and are not intended to be in any way limiting. Reference is made in detail to implementations of examples as illustrated in the accompanying drawings. The same reference indicators are used throughout the drawings and the description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another. That is, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in an embodiment,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a computing apparatus comprising: a computer-readable storage medium; processor-executable instructions stored on the computer-readable storage medium; and one or more processors coupled to the computer-readable storage medium and configured to execute the processor-executable instructions to operate a Binding Support Function (BSF) within a network, wherein the BSF comprises a binding restoration engine, such that the processor-executable instructions, when executed by the one or more processors, direct the computing apparatus, to at least: determine an Rx request from a first network function (NF) within the network, where in the Rx request is associated with a session created between a second NF and a Policy Control Function (PCF) within the network; determine a lack of a binding for the session between the second NF and the PCF; generate a discovery request comprising one or more PCF parameters based on the Rx request; transmit the discovery request to a Network Repository Function (NRF) within the network; receive a discovery list from the NRF responsive to the discovery request, wherein the discovery list comprises a plurality of PCF sets; transmit a binding retrieval query to each PCF set within the plurality of PCF sets identified in the discovery list; and initiate restoration of the binding for the session based on a response from a first PCF within a first PCF set of the plurality of PCF sets, wherein the first PCF set is associated with the session between the second NF and the PCF.

Example 2 is the computing apparatus of any previous or subsequent Example, wherein the processor-executable instructions, when executed by the one or more processors, further direct the computing apparatus to: determine operator criteria and configuration based on the Rx request; and generate an acceptance response comprising a host identifier of the BSF; and transmit the acceptance response to the first NF, wherein responsive to receiving the acceptance response the first NF allows an IMS-based session corresponding to the session between the second NF and the PCF to proceed.

Example 3 is the computing apparatus of any previous or subsequent Example, wherein the processor-executable instructions to transmit the binding retrieval query to each PCF set within the plurality of PCF sets identified in the discovery list, when executed by the one or more processors, further direct the computing apparatus to: determine a first PCF within each of the PCF sets of the plurality of PCF sets based on a respective NF profile received in the discovery list; and transmit the binding retrieval query to the first PCF within each of the PCF sets.

Example 4 is the computing apparatus of any previous or subsequent Example, wherein the processor-executable instructions to generate the discovery request comprising the one or more PCF parameters, when executed by the one or more processors, further direct the computing apparatus to: determine the one or more PCF parameters, wherein the one or more PCF parameters comprise one or more an NFType, preferred-locality, service, or supportedVendorSpecificFeatures; and generate the discovery request comprising the one or more PCF parameters.

Example 5 is the computing apparatus of any previous or subsequent Example, wherein the processor-executable instructions to transmit the binding retrieval query to each PCF set within the plurality of PCF sets identified in the discovery list, when executed by the one or more processors, further direct the computing apparatus to: generate the binding retrieval query comprising a RegisterIfFound request and one or more query parameter.

Example 6 is the computing apparatus of any previous or subsequent Example, wherein the processor-executable instructions, when executed by the one or more processors, further direct the computing apparatus to: receive, from the first NF, an update request subsequent to restoration of the binding; and initiate creation, by the first NF, of an IMS-based session corresponding to the session between the second NF and the PCF.

Example 7 is a method comprising: determining, by a binding restoration engine of a Binding Support Function (BSF), an Rx request from a first network function (NF), where in the Rx request is associated with a session created between a second NF and a Policy Control Function (PCF) within a network; determining, by the binding restoration engine, a lack of a binding for the session created between the second NF and the PCF within the network; accepting, by the BSF, the Rx request to allow an IMS-based session corresponding to the session between the second NF and the PCF to proceed; auditing, by the binding restoration engine, the network to identify the PCF associated with the binding; and initiating, by the binding restoration engine, a binding restoration process by the PCF.

Example 8 is the method of any previous or subsequent Example, wherein: auditing, by the binding restoration engine, the network to identify the PCF associated with the binding comprises sending, by the binding restoration engine, a binding retrieval query to a plurality of PCFs within the network; and the method further comprises: receiving, by the PCF, the binding retrieval query from the BSF; determining, by the PCF, the binding based on the binding retrieval query; and performing, by the PCF, the binding restoration process based on the binding retrieval query.

Example 9 is the method of any previous or subsequent Example, wherein auditing, by the binding restoration engine, the network to identify the PCF associated with the binding comprises: querying, by the binding restoration engine, a Network Repository Function (NRF) within the network to determine a plurality of PCFs based on the Rx request; generating, by the binding restoration engine, a binding retrieval query based on the Rx request; transmitting, by the binding restoration engine, the binding retrieval query to a subset of PCFs within the plurality of PCFs; and receiving, by the binding restoration engine, a response from the PCF associated with the binding, wherein the plurality of PCFs comprise the PCF.

Example 10 is the method of any previous or subsequent Example, wherein the method further comprises: registering, by the PCF associated with the binding, a bindingRestore parameter with a Network Repository Function (NRF) of the network.

Example 11 is the method of any previous or subsequent Example, wherein the network is a 5G network, the first NF is a proxy-Call Session Control Function (P-CSCF), and the second NF is a Session Management Function (SMF).

Example 12 is the method of any previous or subsequent Example, wherein auditing, by the binding restoration engine, the network to identify the PCF associated with the binding comprises: transmitting, by the binding restoration engine, a discovery request to a Network Repository Function (NRF) within the network; receiving, by the binding restoration engine, a discovery list from the NRF, wherein the discovery list comprises one or more PCF sets; and transmitting, by the binding restoration engine, a binding retrieval query to a first PCF within each of the one or more PCF sets.

Example 13 is the method of any previous or subsequent Example, wherein accepting, by the BSF, the Rx request to allow the IMS-based session corresponding to the session between the second NF and the PCF to proceed comprises: determining, by the binding restoration engine, operator criteria and configuration based on the Rx request; and generating, by the binding restoration engine, an acceptance response comprising a host identifier of the BSF; and transmitting, by the BSF, the acceptance response to the first NF, wherein responsive to receiving the acceptance response the first NF allows the IMS-based session corresponding to the session between the second NF and the PCF to proceed.

Example 14 is the method of any previous or subsequent Example, wherein: auditing, by the binding restoration engine, the network to identify the PCF associated with the binding comprises sending, by the binding restoration engine, a binding retrieval query to a plurality of PCFs within the network; and the method further comprises: receiving, by a first PCF of the plurality of PCFs, the binding retrieval query; failing, by the first PCF, to identify the binding that is associated with the session; and transmitting, by the first PCF, a notFound response to the BSF.

Example 15 is a computer-readable storage medium comprising processor-executable instructions, wherein the processor-executable instructions, in part, operate a Binding Support Function (BSF) within a network such to cause one or more processors to: determine, by a binding restoration engine, a lack of a binding for a session created between a first network function (NF) and a first Policy Control Function (PCF) within the network; transmit, by the binding restoration engine, a discovery request to a Network Repository Function (NRF) within the network; receive, by the binding restoration engine, a discovery list from the NRF responsive to the discovery request, wherein the discovery list comprises a plurality of PCFs within the network; determine, by the binding restoration engine, the first PCF associated with the session from the plurality of PCFs; and initiate, by the binding restoration engine, a binding restoration process for the respective session to restore the binding at the BSF.

Example 16 is the computer-readable storage medium of any previous or subsequent Example, wherein the processor-executable instructions cause the one or more processors to further execute processor-executable instructions stored in the computer-readable storage medium to: determine, by the binding restoration engine, an Rx request from a Proxy-Call Session Control Function (P-CSCF) within the network, wherein the Rx request is associated with the session between the first NF and the first PCF; and store, by the binding restoration engine, the Rx request.

Example 17 is the computer-readable storage medium of any previous or subsequent Example, wherein the plurality of PCFs in the discovery list comprise a plurality of PCF sets and the processor-executable instructions to determine, by the binding restoration engine, the first PCF associated with the session form the plurality of PCFs cause the one or more processors to further execute processor-executable instructions stored in the computer-readable storage medium to: generate, by the binding restoration engine, a binding retrieval query; selecting, by the binding restoration engine, a priority PCF within each PCF set of the plurality of PCF sets provided in the discovery list based on priority of the respective priority PCF within each PCF set; transmitting, by the binding restoration engine, the binding retrieval query to the priority PCF within each PCF set; and receiving, by the binding restoration engine, a response from the first PCF within a first PCF set of the plurality of PCF sets.

Example 18 is the computer-readable storage medium of any previous or subsequent Example, wherein the processor-executable instructions cause the one or more processors to further execute processor-executable instructions stored in the computer-readable storage medium to: determine, by the binding restoration engine, an Rx request from a Proxy-Call Session Control Function (P-CSCF) within the network, wherein the Rx request is associated with the session between the first NF and the first PCF; generate, by the binding restoration engine, an acceptance response comprising a host identifier of the BSF; and transmit, by the binding restoration engine, the acceptance response to the P-CSCF, wherein responsive to receiving the acceptance response the P-CSCF initiates an IMS-based session corresponding to the session between the first NF and the PCF.

Example 19 is the computer-readable storage medium of any previous or subsequent Example, wherein the processor-executable instructions transmit, by the binding restoration engine, a discovery request to the NRF within the network cause the one or more processors to further execute processor-executable instructions stored in the computer-readable storage medium to: determine, by the binding restoration engine, one or more PCF parameters associated with the session between the first NF and the first PCF, wherein the one or more PCF parameters comprise one or more an NFType, preferred-locality, service, or supportedVendorSpecificFeatures; and generate, by the binding restoration engine, the discovery request comprising the one or more PCF parameters.

Example 20 is the computer-readable storage medium of any previous or subsequent Example, wherein the processor-executable instructions to initiate, by the binding restoration engine, the binding restoration process for the respective session to restore the binding at the BSF cause the one or more processors to further execute processor-executable instructions stored in the computer-readable storage medium to: transmit, by the binding restoration engine, a binding retrieval query to the first PCF, wherein the first PCF, responsive to receiving the binding retrieval query: identifies the binding associated with the session between the first NF and the first PCF; and performs a binding restoration process to restore the binding at the BSF.

What is claimed is:

1. A computing apparatus comprising:
a computer-readable storage medium;
processor-executable instructions stored on the computer-readable storage medium; and
one or more processors coupled to the computer-readable storage medium and configured to execute the processor-executable instructions to operate a Binding Support Function (BSF) within a network, wherein the BSF comprises a binding restoration engine, such that the processor-executable instructions, when executed by the one or more processors, direct the computing apparatus, to at least:
determine an Rx request from a first network function (NF) within the network, where in the Rx request is associated with a session created between a second NF and a Policy Control Function (PCF) within the network;
determine a lack of a binding for the session between the second NF and the PCF;
generate a discovery request comprising one or more PCF parameters based on the Rx request;
transmit the discovery request to a Network Repository Function (NRF) within the network;
receive a discovery list from the NRF responsive to the discovery request, wherein the discovery list comprises a plurality of PCF sets;
transmit a binding retrieval query to each PCF set within the plurality of PCF sets identified in the discovery list; and
initiate restoration of the binding for the session based on a response from a first PCF within a first PCF set of the plurality of PCF sets, wherein the first PCF set is associated with the session between the second NF and the PCF.

2. The computing apparatus of claim 1, wherein the processor-executable instructions, when executed by the one or more processors, further direct the computing apparatus to:
determine operator criteria and configuration based on the Rx request; and
generate an acceptance response comprising a host identifier of the BSF; and
transmit the acceptance response to the first NF, wherein responsive to receiving the acceptance response the first NF allows an IMS-based session corresponding to the session between the second NF and the PCF to proceed.

3. The computing apparatus of claim 1, wherein the processor-executable instructions to transmit the binding retrieval query to each PCF set within the plurality of PCF sets identified in the discovery list, when executed by the one or more processors, further direct the computing apparatus to:
determine a first PCF within each of the PCF sets of the plurality of PCF sets based on a respective NF profile received in the discovery list; and
transmit the binding retrieval query to the first PCF within each of the PCF sets.

4. The computing apparatus of claim 1, wherein the processor-executable instructions to generate the discovery request comprising the one or more PCF parameters, when executed by the one or more processors, further direct the computing apparatus to:
determine the one or more PCF parameters, wherein the one or more PCF parameters comprise one or more an NFType, preferred-locality, service, or supportedVendorSpecificFeatures; and
generate the discovery request comprising the one or more PCF parameters.

5. The computing apparatus of claim 1, wherein the processor-executable instructions to transmit the binding retrieval query to each PCF set within the plurality of PCF sets identified in the discovery list, when executed by the one or more processors, further direct the computing apparatus to:
generate the binding retrieval query comprising a RegisterIfFound request and one or more query parameter.

6. The computing apparatus of claim 1, wherein the processor-executable instructions, when executed by the one or more processors, further direct the computing apparatus to:
receive, from the first NF, an update request subsequent to restoration of the binding; and
initiate creation, by the first NF, of an IMS-based session corresponding to the session between the second NF and the PCF.

7. A method comprising:
determining, by a binding restoration engine of a Binding Support Function (BSF), an Rx request from a first network function (NF), where in the Rx request is associated with a session created between a second NF and a Policy Control Function (PCF) within a network;
determining, by the binding restoration engine, a lack of a binding for the session created between the second NF and the PCF within the network;
accepting, by the BSF, the Rx request to allow an IMS-based session corresponding to the session between the second NF and the PCF to proceed;
auditing, by the binding restoration engine, the network to identify the PCF associated with the binding; and
initiating, by the binding restoration engine, a binding restoration process by the PCF.

8. The method of claim 7, wherein:
auditing, by the binding restoration engine, the network to identify the PCF associated with the binding comprises sending, by the binding restoration engine, a binding retrieval query to a plurality of PCFs within the network; and
the method further comprises:
receiving, by the PCF, the binding retrieval query from the BSF;
determining, by the PCF, the binding based on the binding retrieval query; and
performing, by the PCF, the binding restoration process based on the binding retrieval query.

9. The method of claim 7, wherein auditing, by the binding restoration engine, the network to identify the PCF associated with the binding comprises:
querying, by the binding restoration engine, a Network Repository Function (NRF) within the network to determine a plurality of PCFs based on the Rx request;
generating, by the binding restoration engine, a binding retrieval query based on the Rx request;
transmitting, by the binding restoration engine, the binding retrieval query to a subset of PCFs within the plurality of PCFs; and
receiving, by the binding restoration engine, a response from the PCF associated with the binding, wherein the plurality of PCFs comprise the PCF.

10. The method of claim 7, wherein the method further comprises:
registering, by the PCF associated with the binding, a bindingRestore parameter with a Network Repository Function (NRF) of the network.

11. The method of claim 7, wherein the network is a 5G network, the first NF is a proxy-Call Session Control Function (P-CSCF), and the second NF is a Session Management Function (SMF).

12. The method of claim 7, wherein auditing, by the binding restoration engine, the network to identify the PCF associated with the binding comprises:
transmitting, by the binding restoration engine, a discovery request to a Network Repository Function (NRF) within the network;
receiving, by the binding restoration engine, a discovery list from the NRF, wherein the discovery list comprises one or more PCF sets; and
transmitting, by the binding restoration engine, a binding retrieval query to a first PCF within each of the one or more PCF sets.

13. The method of claim 7, wherein accepting, by the BSF, the Rx request to allow the IMS-based session corresponding to the session between the second NF and the PCF to proceed comprises:
determining, by the binding restoration engine, operator criteria and configuration based on the Rx request; and
generating, by the binding restoration engine, an acceptance response comprising a host identifier of the BSF; and
transmitting, by the BSF, the acceptance response to the first NF, wherein responsive to receiving the acceptance response the first NF allows the IMS-based session corresponding to the session between the second NF and the PCF to proceed.

14. The method of claim 7, wherein:
auditing, by the binding restoration engine, the network to identify the PCF associated with the binding comprises sending, by the binding restoration engine, a binding retrieval query to a plurality of PCFs within the network; and
the method further comprises:
receiving, by a first PCF of the plurality of PCFs, the binding retrieval query;
failing, by the first PCF, to identify the binding that is associated with the session; and
transmitting, by the first PCF, a notFound response to the BSF.

15. A computer-readable storage medium comprising processor-executable instructions, wherein the processor-executable instructions, in part, operate a Binding Support Function (BSF) within a network such to cause one or more processors to:
determine, by a binding restoration engine, a lack of a binding for a session created between a first network function (NF) and a first Policy Control Function (PCF) within the network;
transmit, by the binding restoration engine, a discovery request to a Network Repository Function (NRF) within the network;
receive, by the binding restoration engine, a discovery list from the NRF responsive to the discovery request, wherein the discovery list comprises a plurality of PCFs within the network;
determine, by the binding restoration engine, the first PCF associated with the session from the plurality of PCFs; and
initiate, by the binding restoration engine, a binding restoration process for the respective session to restore the binding at the BSF.

16. The computer-readable storage medium of claim 15, wherein the processor-executable instructions cause the one or more processors to further execute processor-executable instructions stored in the computer-readable storage medium to:
determine, by the binding restoration engine, an Rx request from a Proxy-Call Session Control Function (P-CSCF) within the network, wherein the Rx request is associated with the session between the first NF and the first PCF; and
store, by the binding restoration engine, the Rx request.

17. The computer-readable storage medium of claim 15, wherein the plurality of PCFs in the discovery list comprise a plurality of PCF sets and the processor-executable instructions to determine, by the binding restoration engine, the first PCF associated with the session form the plurality of PCFs cause the one or more processors to further execute processor-executable instructions stored in the computer-readable storage medium to:
generate, by the binding restoration engine, a binding retrieval query;
selecting, by the binding restoration engine, a priority PCF within each PCF set of the plurality of PCF sets provided in the discovery list based on priority of the respective priority PCF within each PCF set;
transmitting, by the binding restoration engine, the binding retrieval query to the priority PCF within each PCF set; and
receiving, by the binding restoration engine, a response from the first PCF within a first PCF set of the plurality of PCF sets.

18. The computer-readable storage medium of claim 15, wherein the processor-executable instructions cause the one or more processors to further execute processor-executable instructions stored in the computer-readable storage medium to:
determine, by the binding restoration engine, an Rx request from a Proxy-Call Session Control Function (P-CSCF) within the network, wherein the Rx request is associated with the session between the first NF and the first PCF;
generate, by the binding restoration engine, an acceptance response comprising a host identifier of the BSF; and
transmit, by the binding restoration engine, the acceptance response to the P-CSCF, wherein responsive to receiving the acceptance response the P-CSCF initiates an IMS-based session corresponding to the session between the first NF and the PCF.

19. The computer-readable storage medium of claim 15, wherein the processor-executable instructions transmit, by the binding restoration engine, a discovery request to the NRF within the network cause the one or more processors to further execute processor-executable instructions stored in the computer-readable storage medium to:
determine, by the binding restoration engine, one or more PCF parameters associated with the session between the first NF and the first PCF, wherein the one or more PCF parameters comprise one or more an NFType, preferred-locality, service, or supportedVendorSpecificFeatures; and
generate, by the binding restoration engine, the discovery request comprising the one or more PCF parameters.

20. The computer-readable storage medium of claim 15, wherein the processor-executable instructions to initiate, by the binding restoration engine, the binding restoration process for the respective session to restore the binding at the BSF cause the one or more processors to further execute processor-executable instructions stored in the computer-readable storage medium to:
transmit, by the binding restoration engine, a binding retrieval query to the first PCF, wherein the first PCF, responsive to receiving the binding retrieval query:
identifies the binding associated with the session between the first NF and the first PCF; and
performs a binding restoration process to restore the binding at the BSF.
